(19) United States
(12) Patent Application Publication
(10) Pub. No.: US 2017/0104234 A1
(43) Pub. Date: Apr. 13, 2017

(54) Method and Apparatus of Fabricating Terminal Plate Product

(71) Applicant: Yeil Electronics Co., Ltd, Incheon (KR)

(72) Inventors: Yun Kyu Kang, Gyeonggi-Do (KR); Goo Hyun Kim, Gyeonggi-Do (KR)

(21) Appl. No.: 15/006,564

(22) Filed: Jan. 26, 2016

(30) Foreign Application Priority Data
Oct. 8, 2015 (KR) 10-2015-0141322

(51) Int. Cl. H01M 10/04; H01M 2/30

(52) U.S. Cl. CPC H01M 10/04; H01M 2/30

(57) ABSTRACT

Disclosed is an apparatus of fabricating a terminal plate product according to an exemplary embodiment of the present invention. The apparatus of fabricating the terminal plate product includes: a die plate having one or more spaces in which a terminal plate is received; an upper plate which is positioned on the top of the die plate, is movable to ascend and descend, and presses and processes at least a part of the top of the terminal plate received in one or more spaces through descending movement; a first lower plate which is positioned on the bottom of the die plate, is movable to ascend and descend, and discharges the pressed and processed terminal plate while ascending; and a second lower plate which is positioned on the bottom of the first lower plate, is movable to ascend and descend, has one or more molding pins, press and process at least a part of the bottom of the terminal plate through ascending movement, coupled to the top, and separates the molding pin from the processed terminal plate during descending movement.

This application claims priority to and the benefit of Korean Patent Application No. 10-2015-0141322 filed in the Korean Intellectual Property Office on Oct. 8, 2015, the entire contents of which are incorporated herein by reference.

### TECHNICAL FIELD

The present invention relates to a method and a system of processing a material, and more particularly, to a method and a system of fabricating a terminal plate product.

### BACKGROUND ART

In order to fabricate a terminal plate product, a circular drawn article is generally fabricated through cold forging and cutting processing in the related art. The terminal plate product may be used, for example, for a secondary battery.

Korean Patent Registration No. 10-1233466 discloses a lithium rechargeable battery and a method of making the same.

In more detail, in a method of fabricating a terminal plate product in the related art, in respect to metal, for example, an aluminum steel plate, a presser presses a molding frame on the aluminum steel plate. When the aluminum steel plate is pressed in the shape of the molding frame, the remaining materials is cut by a cutter such as a laser cutter, or the like and thereafter, the pressing is repeated several times in order to generate a hole with a step at the center of the aluminum steel plate to fabricate the terminal plate product.

However, when the terminal plate product is fabricated through the cold forging, it is difficult to implement various shapes and exterior quality of the terminal plate product deteriorates and cost of a processing facility is extremely large.

A cycle time in the cutting processing is longer than the cycle time and a processing facility is more expensive than the processing facility in a press operation.

As a result, there is a demand in the related industry to improve a generation speed of the terminal plate product and reduce processing facility cost.

There is a demand in the related industry to uniformly generate hardness of the terminal plate product and improve surface precision and size precision of the terminal plate product.

### SUMMARY OF THE INVENTION

The present invention has been made in an effort to uniformalize hardness of a terminal plate product.

The present invention has also been made in an effort to improve hardness, surface precision, and size precision of the terminal plate product.

The present invention has also been made in an effort to reduce cost required to fabricate the terminal plate product.

Disclosed is an apparatus of fabricating a terminal plate product according to an exemplary embodiment of the present invention. The apparatus of fabricating the terminal plate product may include: a die plate having one or more spaces in which a terminal plate is received; an upper plate which is positioned on the top of the die plate, is movable to ascend and descend, and presses and processes at least a part of the top of the terminal plate received in one or more spaces through descending movement; a first lower plate which is positioned on the bottom of the die plate, is movable to ascend and descend, and discharges the pressed and processed terminal plate while ascending; and a second lower plate which is positioned on the bottom of the first lower plate, is movable to ascend and descend, and has one or more molding pins, and which press and process at least a part of the bottom of the terminal plate through ascending movement, coupled to the top, and separates the molding pin from the processed terminal plate during descending movement.

Disclosed is a method of fabricating a terminal plate product according to an exemplary embodiment of the present invention. The method of fabricating the terminal plate product may include: providing a terminal plate to a die plate with one or more spaces in which the terminal plate is received; making an upper plate, which is positioned on the top of the die plate and is movable to ascend and descend, descend in order to press and process at least a part of the top of the terminal plate received in one or more spaces through descending movement; making a first lower plate, which is positioned on the bottom of the die plate and is movable to ascend and descend, ascend in order to discharge the pressed and processed terminal plate; and making a second lower plate which is positioned on the bottom of the first lower plate and movable to ascend and descend while one or molding pins which press and process at least a part of the bottom of the terminal plate are coupled to the top descend so as to separate the molding pin from the processed terminal plate.

Disclosed is a terminal plate produced generated by a method of fabricating a terminal plate according to an exemplary embodiment of the present invention. The method may include: providing a terminal plate to a die plate with one or more spaces in which the terminal plate is received; making an upper plate, which is positioned on the top of the die plate, is movable to ascend and descend, descend in order to press and process at least a part of the top of the terminal plate received in one or more spaces through descending movement; making a first lower plate, which is positioned on the bottom of the die plate and is movable to ascend and descend, ascend in order to discharge the pressed and processed terminal plate; and making a second lower plate, which is positioned on the bottom of the first lower plate and movable to ascend and descend while one or molding pins which presses at least a part of the bottom of the terminal plate are coupled to the top, descend so as to separate the molding pin from the processed terminal plate.

According to an exemplary embodiment of the present invention, hardness of a terminal plate product can be uniformalized.

According to an exemplary embodiment of the present invention, hardness, surface precision, and size precision of the terminal plate product can be improved.

According to an exemplary embodiment of the present invention, cost required to fabricate the terminal plate product can be reduced.

### BRIEF DESCRIPTION OF THE DRAWINGS

Various aspects are now described with reference to the drawings and like reference numerals are generally used to designate like elements. In the following exemplary embodiments, for description, multiple specific detailed matters are presented to provide general understanding of one or more aspects. However, it will be apparent that the aspect(s) can be executed without the detailed matters. In other examples, known structures and apparatuses are illustrated in a block diagram form in order to facilitate description of the embodiments.

Various aspects are now described with reference to the drawings and like reference numerals are generally used to designate like elements. In the following exemplary embodiments, for description, multiple specific detailed matters are presented to provide general understanding of one or more aspects. However, it will be apparent that the aspect(s) can be executed without the detailed matters. In other examples, known structures and apparatuses are illustrated in a block diagram form in order to facilitate description of the embodiments.

FIG. 1 is a flowchart of a method of fabricating terminal plate materials according to an exemplary embodiment of the present invention.

FIGS. 2A-2B illustrate a first drawing process for fabricating terminal plate materials and a cross-section of a first metal drawing material generated by the first drawing process according to an exemplary embodiment of the present invention.

FIGS. 3A-3B illustrate a rolling process for fabricating terminal plate materials and a cross-section of a metallic rolling material generated by the rolling process according to an exemplary embodiment of the present invention.

FIGS. 4A-4C illustrate a second drawing process for fabricating terminal plate materials and a cross-section of the second metal drawing material generated by the second drawing process according to an exemplary embodiment of the present invention.

FIGS. 5A-5B illustrates an exemplary diagram of a material generated in each of processes of fabricating terminal plate materials according to an exemplary embodiment of the present invention.

FIG. 6 is a flowchart of a method of fabricating a terminal plate according to an exemplary embodiment of the present invention.

FIG. 7 is a flowchart of a method of fabricating a terminal plate according to another exemplary embodiment of the present invention.

FIG. 8 is a plan view of a system of fabricating a terminal plate according to an exemplary embodiment of the present invention.

FIGS. 9A-9B are plan views of a piercing part and a cutting unit of an apparatus of fabricating a terminal plate according to an exemplary embodiment of the present invention.

FIG. 10A-10B illustrate a generated terminal plate and a material of the terminal plate generated in each process according to an exemplary embodiment of the present invention.

FIG. 11 is a flowchart of a method of fabricating a terminal plate product according to an exemplary embodiment of the present invention.

FIGS. 12A-12B are plan views of an apparatus of fabricating a terminal plate product according to an exemplary embodiment of the present invention.

FIG. 13 illustrates a terminal plate product according to an exemplary embodiment of the present invention.

FIG. 14 is a flowchart of a method of fabricating a terminal plate product with a metal wire according to an exemplary embodiment of the present invention.

### DETAILED DESCRIPTION

Various exemplary embodiments and/or aspects are disclosed with reference to drawings. In the following description, for description, multiple detailed matters are disclosed in order to help overall understanding of one or more aspects. However, those skilled in the art will be able to recognize even that the aspect(s) can be executed without the detailed matters. In the following disclosure and the accompanying drawings, specific exemplary aspects of one or more aspects will be described in detail. However, the aspects are exemplary and some among various methods in principles of various aspects may be used and the descriptions are intended to include all of the aspects and equivalents thereof.

In “exemplary embodiment”, “example”, “aspect”, “illustration”, and the like used in the specification, it may not be construed that a predetermined or design are more excellent or advantageous than other aspects or designs.

Moreover, a term “or” is intended to mean not exclusive “or” but inclusive “or”. That is, when not separately specified or not clear in terms of a context, the case where “X uses A or B” is intended to mean one of natural inclusive substitutions. That is, the case where “X uses A or B” may be applied to either of the case where X uses A, the case where X uses B, or the case where X uses both A and B. Further, it should be understood that a term “and/or used in the specification designate and include all available combinations of one or more items among enumerated related items.

The word “comprises” and/or “comprising” means that the corresponding feature and/or component is present, but it should be appreciated that presence or inclusion of one or more other features, components, and/or a group thereof is not excluded. Further, when not separately specified or not clear in terms of the context by indicating a singular form, it should be construed that the singular generally means “one or more”.

The present invention will be described below with reference to the presented accompanying drawings.

First, a methodological part of the present invention will be described.

In the present invention, in order to fabricate a terminal plate or terminal plate materials, a metal wire is adopted as a processed material and the metal wire includes preferably a metal wire with conductivity and may include, for example, an aluminum material, a magnesium material, a titanium material, a steel material, a copper material, and the like. In order to fabricate the terminal plate materials by using the metal wire, steps to be described below will be performed in the present invention.

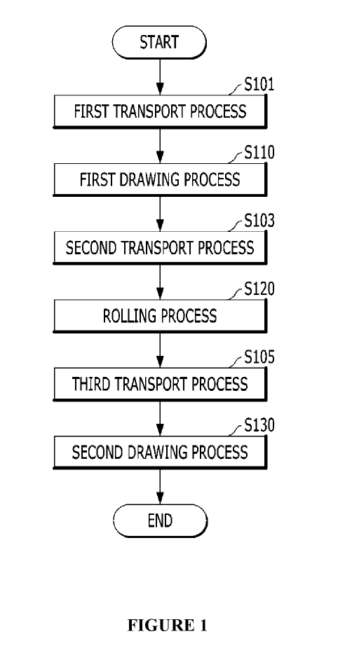

FIG. 1 is a flowchart of a method of fabricating terminal plate materials according to an exemplary embodiment of the present invention.

Referring to FIG. 1, a method of fabricating terminal plate materials according to an exemplary embodiment of the present invention may include a first drawing process, a rolling process, and a second drawing process.

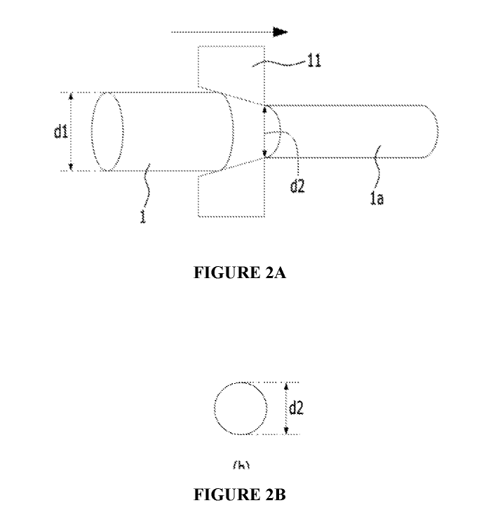

In order to fabricate the terminal plate materials according to the exemplary embodiment of the present invention, a metal wire passes through a first die having a circular hole with a smaller diameter than the metal wire to form a first metal drawing material having a cross-sectional shape, which corresponds to the circular hole (S110). Hereinafter, step S110 is collectively referred to as “first drawing process” and the first drawing process will be described with reference to FIG. 2A.

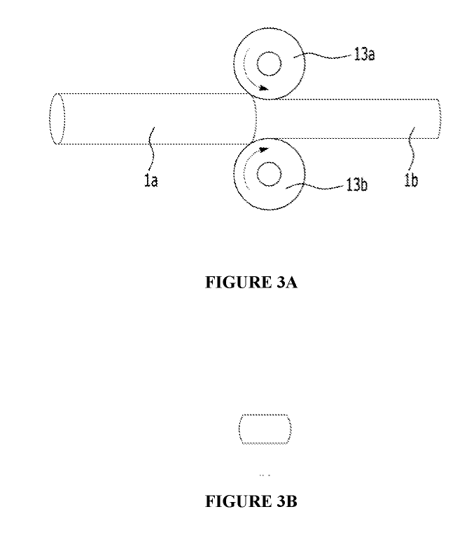

According to the exemplary embodiment of the present invention, the first metal drawing material generated by the first drawing process passes between at least two rollers which rotate to generate a metal rolling material (S120). Hereinafter, step S120 is collectively referred to as a “rolling process” and the rolling process will be described with reference to FIG. 3A.

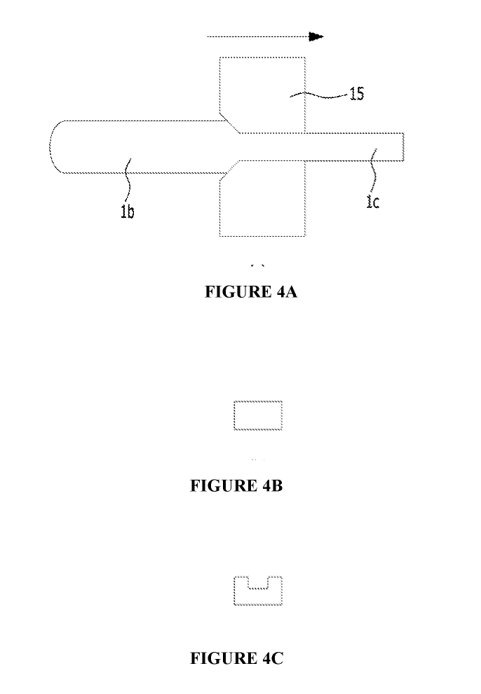

According to the exemplary embodiment of the present invention, the metal rolling material passes through a second die having a predetermined cross-section to generate a second metal drawing material having a cross-sectional shape, which corresponds to the predetermined cross-section (S130). The predetermined cross-section may have, for example, a quadrangular shape or a multi-step shape. Hereinafter, step S130 is collectively referred to as a “second drawing process” and the second drawing process will be described with reference to FIG. 4A.

The first drawing process, the rolling process, and the second drawing process may be consecutively performed in one fabricating apparatus or fabricating process or individually performed in a plurality of fabricating apparatuses or a plurality of fabricating processes.

In an additional exemplary embodiment of the present invention, the method of fabricating the terminal plate materials may further include a first transport process, a second transport process, and a third transport process.

According to the exemplary embodiment of the present invention, the metal wire may be transported to the first die (S101). This is referred to as a “first transport process”.

The first metal drawing material generated by the first drawing process (S110) may be transported between at least two rollers (S103). This is referred to as a “second transport process”.

The metal rolling material generated by the rolling process (S120) may be transported to the second die (S105). This is referred to as a “third transport process”.

In summary, by the method of fabricating the terminal plate materials according to the exemplary embodiment of the present invention, the metal wire may be transported to the first die by the first transport process (S101). The transported metal wire passes through the first die having a circular hole with a smaller diameter than the metal wire to form the first metal drawing material having a cross-sectional shape, which corresponds to the circular hole (S110). The first metal drawing material generated through step S110 may be transported between at least two rollers (S103). The transported first metal drawing material passes between at least two rollers that rotate to generate the metal rolling material (S120). The metal rolling material generated through step S120 may be transported to the second die by the third transport process (S105). The metal rolling material passes through the second die having a predetermined cross-section through the second drawing process to generate the second metal drawing material having the cross-sectional shape, which corresponds to the predetermined cross-section (S130).

In the additional exemplary embodiment of the present invention, the method of fabricating the terminal plate materials may further include a monitoring process of monitoring a quality state of at least one of the first metal drawing material, the metal rolling material, and the second metal drawing material.

Herein, the quality state may be evaluated at least partially based on a hardness measurement value per predetermined interval of at least one of the first metal drawing material, the metal rolling material, and the second metal drawing material.

For example, by the method of fabricating the terminal plate materials according to the exemplary embodiment of the present invention, the quality state of the metal rolling material may be monitored partially based on the hardness measurement value per predetermined interval with respect to the metal rolling material generated by the rolling process.

An operation of the present invention which is performed as described above will be described with reference to FIGS. 2A to 5B to be described below.

FIGS. 2A-2B illustrate a first drawing process for fabricating terminal plate materials and a cross-section of a first metal drawing material generated by the first drawing process according to an exemplary embodiment of the present invention.

Referring to FIG. 2A, the “first drawing process” will be described in more detail. In the present invention, in order to fabricate the terminal plate materials, a metal wire 1 is adopted as a processed material and the metal wire 1 preferably includes a metal wire having conductivity and may be, for example, an aluminum material.

A first die 11 illustrated in FIG. 2A has a circular hole having a diameter d2 smaller than a diameter d1 of the metal wire 1. The metal wire 1 passes through the first die 11 to generate a first metal drawing material 1a having a cross-sectional shape, which corresponds to the circular hole. The cross-section of the first metal drawing material 1a generated by the first drawing process will be described with reference to FIG. 2B. Additionally, an arrow shown on the top of the first die 11 of FIG. 2A indicates a transport direction of the metal wire 1.

That is, the diameter d2 of the first die 11 is smaller than the diameter d1 of the metal wire 1 and the transported metal wire 1 passes through the hole of the first die 11 to generate the first metal drawing material 1a having the smaller diameter than the metal wire 1. That is, the metal wire 1 having the first diameter d1 may be processed to the first metal drawing material having the second diameter d2.

In more detail, the metal wire 1 may be generated to the first metal drawing material 1a which is thin and smooth and has high hardness through the first drawing process. The first metal drawing material 1a generated by the first drawing process may have uniform hardness, a precise size, and improved surface roughness compared to the metal wire 1.

The first drawing process may adopt, for example, a cold drawing scheme, but the present invention is not limited thereto. Herein, in the cold drawing, a drawing process is performed by cold processing and the cold processing means plastically deforming and processing a metallic material at a temperature lower than a recrystallization temperature of the metallic material. A crystalline grain of the first metal drawing material 1a may be tempered to be fine and uniform through the cold drawing.

The diameter of the circular hole in the first drawing process described above may be changed based on at least one of the type of metal, the diameter of the metal wire, the hardness of the metal wire, a predetermined diameter of the first metal drawing material, predetermined hardness of the first metal drawing material, predetermined hardness of the metal rolling material, a predetermined height of the metal rolling material, predetermined hardness of the second metal drawing material, a predetermined height of the second metal drawing material, predetermined hardness of the terminal plate materials, and predetermined heights of the terminal plate materials.

In the drawings, it is illustrated that both ends of the first metal drawing material fabricated by the drawing process have the same shape and area, but the case where both ends have different shapes and areas may also be included in the scope of the present invention.

Hereinafter, a rolling process of fabricating terminal plate materials according to an exemplary embodiment of the present invention will be described with reference to FIGS. 3A-3B.

FIGS. 3A-3B illustrate a rolling process for fabricating terminal plate materials and a cross-section of a metallic rolling material generated by the rolling process according to an exemplary embodiment of the present invention.

Referring to FIG. 3A, the “rolling process” will be described in more detail.

In the rolling process of fabricating the terminal plate materials according to the exemplary embodiment of the present invention, the metal drawing material 1a generated by the first drawing process is adopted as a process material.

Through the rolling process according to the exemplary embodiment of the present invention, the first metal drawing material 1a generated by the first drawing process described above in FIG. 2A passes between at least two rollers 13a and 13b that rotate to generate a metal rolling material 1b. The cross-section of the metal rolling material 1b generated by the rolling process will be described with reference to FIG. 3B. Additionally, an arrow shown on the top of an upper roller 13a of FIG. 3A indicates a transport direction of the first metal drawing material 1a.

In the additional exemplary embodiment of the present invention, an interval between at least two rollers 13a and 13b may be changed based on at least one of the height of the first metal drawing material 1a and the hardness of the first metal drawing material 1a. Additionally, the interval between at least two rollers 13a and 13b may be changed based on the predetermined height and/or hardness of the metal rolling material 1b.

The rolling process may be performed, for example by a cold scheme. The rolling process of the cold scheme may solve a problem in that the surface cannot be cleanly processed by oxidation caused due to a high temperature as compared with a rolling process of a high-temperature scheme and may achieve a small thickness and high size precision. However, the present invention is not limited thereto.

Hereinafter, a second drawing process of fabricating terminal plate materials according to an exemplary embodiment of the present invention will be described with reference to FIGS. 4A-4C.

FIGS. 4A-4C illustrate a second drawing process for fabricating terminal plate materials and a cross-section of a second metal drawing material generated by the second drawing process according to an exemplary embodiment of the present invention.

Referring to FIG. 4A, the “second drawing process” will be described in more detail.

In the rolling process of fabricating the terminal plate materials according to the exemplary embodiment of the present invention, the metal drawing material 1b generated by the rolling process is adopted as the process material.

Through the second drawing process according to the exemplary embodiment of the present invention, the metal rolling material 1b generated by the rolling process described in FIG. 3A may be generated as a second metal drawing material 1c.

According to the exemplary embodiment of the present invention, the metal rolling material 1b passes through a second die 15 having the predetermined cross-section (e.g., a rectangular cross-section) to be generated as the second metal drawing material 1c having a cross-sectional shape corresponding to the predetermined cross-section (e.g., the rectangular cross-section). The predetermined cross-section may have, for example, the quadrangular shape or the multi-step shape and the present invention is not limited thereto. The cross-section of the second metal drawing material 1c generated by the second drawing process will be described with reference to FIGS. 4B and 4C. Additionally, an arrow shown on the top of the second die 15 of FIG. 4A indicates a transport direction of the metal rolling material 1b.

The second drawing process may adopt, for example, the cold drawing scheme, but the present invention is not limited thereto.

In the second drawing process, a horizontal length of the predetermined cross-section, a vertical length of the predetermined cross-section, and an area of the predetermined cross-section may be changed based on a horizontal length of the metal rolling material, a vertical length of the metal rolling material, and an area of the metal rolling material. Additionally, the predetermined cross-sectional shape may be a quadrangular shape or a quadrangular shape with quadrangular grooves, but the scope of the present invention is not limited thereto.

The first drawing process and the second drawing process according to the exemplary embodiments of the present invention may further include a lubricating process. The life-span of the die and surface precision of the first and second metal drawing materials 1a and 1c may be improved through the lubricating process. Further, a drawing load and a drawing temperature may be decreased. Additionally, drawing speeds in the first and second drawing processes may vary depending on the type and a cross-section reduction rate of the metal.

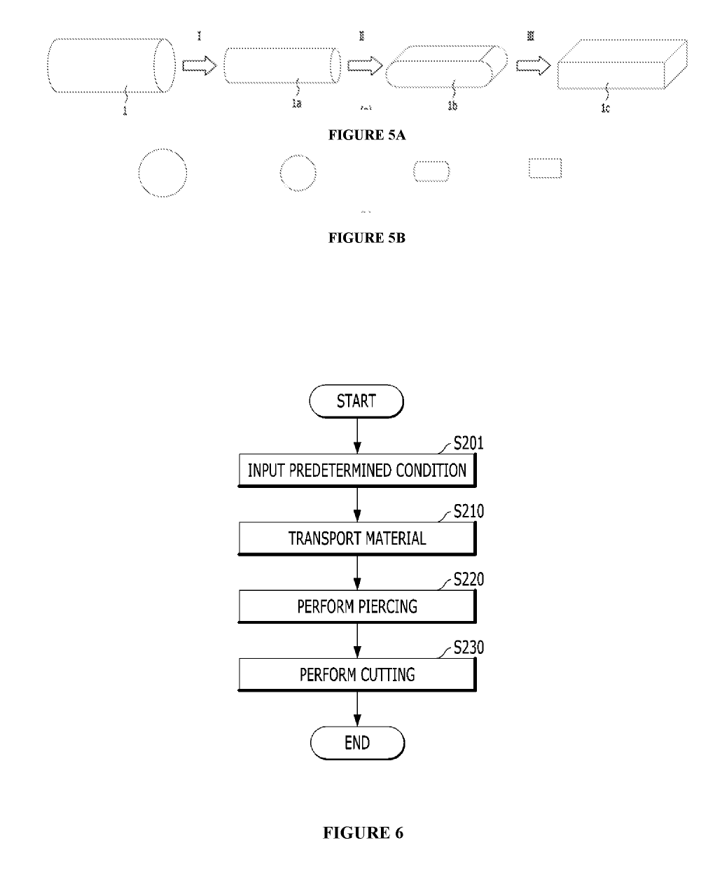

FIGS. 5A-5B illustrate an exemplary diagram of a material generated in each of processes of fabricating terminal plate materials of a metal wire according to an exemplary embodiment of the present invention.

The terminal plate materials generated according to the first drawing process, the rolling process, and the second drawing process described through FIGS. 2A to 4C are illustrated in FIG. 5.

In more detail, referring to FIG. 5A, the metal wire 1 which is the processed material for fabricating the terminal plate materials may be generated as the first metal drawing material 1a having a circular cross-section with the smaller diameter by the first drawing process I. The first metal drawing material 1a has higher hardness than the metal wire 1 and the hardness may be uniform. Further, according to the exemplary embodiment of the present invention, the first metal drawing material 1a may be generated as the metal rolling material 1b by the rolling process II. Additionally, according to the exemplary embodiment of the present invention, the metal rolling material 1b may be generated as the second metal drawing material 1c by the second drawing process III.

According to the exemplary embodiment of the present invention, the respective cross-sectional shapes of the first metal drawing material 1a, the metal rolling material 1b, and the second metal drawing material 1c which may be generated from the metal wire 1 are described with reference to FIG. 5B and the scope of the present invention is not limited thereto.

Those skilled in the art will understand that the first metal drawing material 1a, the metal rolling material 1b, and the second metal drawing material 1c generated by the first drawing process I, the rolling process II, and the second drawing process III are processed from the metal wire 1 and all made of the same material. In other words, the first metal drawing material 1a and the second metal drawing material 1c mean the metal drawing material generated by the first drawing process I and the metal drawing material generated by the second drawing process. That is, it is clear that ‘first metal’ of the first metal drawing material 1a and ‘second metal’ of the second metal drawing material 1c which are terms used in the present specification are not expressions representing that metals are different from each other.

The hardness of the first metal drawing material 1a, the metal rolling material 1b, and the second metal drawing material 1c generated by the first drawing process I, the rolling process II, and the second drawing process III may be uniform. Further, the surface precision, the size precision, and the hardness of the first metal drawing material 1a, the metal rolling material 1b, and the second metal drawing material 1c may be improved.

Next, a system of fabricating terminal plate materials, which is used for implementing the method of fabricating the terminal plate materials described in FIGS. 1 to 4 will be described.

The system of fabricating the terminal plate materials according to the exemplary embodiment of the present invention may include a first drawing unit, a rolling unit, and a second drawing unit.

In the case of the first drawing unit according to the exemplary embodiment of the present invention, the metal wire passes through the first die having the circular hole with the smaller diameter than the metal wire to form the first metal drawing material having the cross-sectional shape, which corresponds to the circular hole.

The rolling unit according to the exemplary embodiment of the present invention passes the first metal drawing material generated by the first process between two rollers 13a and 13b that rotate to generate the metal rolling material.

In an aspect of the present invention, the second drawing unit may include an injection hole having a predetermined shape (e.g., a rectangular shape) on one end and a discharge hole having a predetermined shape on the other end. Further, the shapes of the injection hole and the discharge hole may be variably set as described above.

The second drawing unit according to the exemplary embodiment of the present invention makes the metal rolling material pass through the second die having the predetermined cross-section to generate the second metal drawing material having the cross-sectional shape, which corresponds to the predetermined cross-section.

In an aspect of the present invention, the first drawing unit may include an injection hole having a predetermined shape (e.g., a circular shape) on one end and a discharge hole having a predetermined shape on the other end. Further, the shapes of the injection hole and the discharge hole may be variably set as described above.

In an additional aspect of the present invention, the rolling unit may include two or more rollers. Further, the rolling unit according to an aspect of the present invention may include an upper roller, a lower roller, a material inflow unit, and a material outflow unit. Herein, the material inflow unit may include an impurity removing unit that senses impurities for the first metal drawing material and removes the sensed impurities. Moreover, the upper roller and the lower roller may rotate on a plane axis.

In an additional aspect of the present invention, the second drawing unit may include an injection hole having a predetermined shape (e.g., the rectangular shape) on one end and a discharge hole having a predetermined shape on the other end. Further, the shapes of the injection hole and the discharge hole may be variably set as described above.

The system of fabricating the terminal plate materials according to the exemplary embodiment of the present invention may be implemented to find more components than the first drawing unit, the rolling unit, and the second drawing unit or have fewer components than the first drawing unit, the rolling unit, and the second drawing unit.

Hereinafter, a method and an apparatus of generating the terminal plate from the material (that is, the second metal drawing material) for fabricating the terminal plate generated by the first drawing process, the rolling process, and the second drawing process will be described with reference to FIGS. 6 to 9B.

First, a methodical part of the present invention will be described.

FIG. 6 is a flowchart of a method of fabricating a terminal plate according to an exemplary embodiment of the present invention.

In the present invention, in order to fabricate the terminal plate, the metal drawing material (that is, the second metal drawing material) generated by the first drawing process, the rolling process, and the second rolling process described through FIGS. 1 to 5B is adopted as the processed material. The metal drawing material preferably includes a metal wire having conductivity and may include, for example, an aluminum material, a magnesium material, a titanium material, a steel material, a copper material, and the like. In order to fabricate the terminal plate by using the metal drawing material, steps to be described below will be performed in the present invention. Additionally, the terminal plate fabricated according to the exemplary embodiment of the present invention may be, for example, a secondary battery and the scope of the present invention is not limited thereto.

Referring to FIG. 6, a method of fabricating a terminal plate according to an exemplary embodiment of the present invention includes a material supplying step, a piercing step, and a cutting step.

A material supplying step according to the exemplary embodiment of the present invention may transport a metal drawing material having a quadrangular or a multi-step shaped section based on a predetermined transport condition (S210).

In the piercing step according to the exemplary embodiment of the present invention, a hole in the metal drawing material transported to the position of the piercing unit may be generated based on the predetermined piercing condition (S220).

In the cutting step according to the exemplary embodiment of the present invention, the metal drawing material may be cut, in which the hole transported to the position of the cutting unit is generated, based on the predetermined cutting condition (S230).

The cutting step according to the exemplary embodiment of the present invention may further include a step of fixing the metal drawing material with the hole by a material fixing unit in order to restrict movement of the metal drawing material with the hole. As a result, the metal drawing material may be accurately cut based on a predetermined cutting condition.

In the cutting step according to the exemplary embodiment of the present invention, a material cutting unit of the cutting unit reciprocates vertically to the metal drawing material to cut the metal drawing material.

The material supplying step, the piercing step, and the cutting step may be consecutively performed in one fabricating apparatus or fabricating process or individually performed in a plurality of fabricating apparatuses or a plurality of fabricating processes.

According to an additional exemplary embodiment of the present invention, at least one of a step of stopping transportation of the metal drawing material during the piercing step and a step of stopping the transportation of the metal drawing material during the cutting step may be further performed.

According to the additional exemplary embodiment of the present invention, a step (S201) of receiving a predetermined condition for fabricating the terminal plate may be further performed. Step S201 may be performed before the material transporting step (S210), the piercing step (S220), and the cutting step (S230). Alternatively, the step S201 of receiving the predetermined condition for fabricating the terminal plate may be performed before the material transporting step (S210), performed before the piercing step (S220), and performed before the cutting step (S230).

The predetermined condition may include at least one of a predetermined transport condition, a predetermined piercing condition, and a predetermined cutting condition. The predetermined transport condition may include at least one of for example, a transport direction, a transport length, a transport speed, and a transport position of the metal drawing material. Further, the predetermined piercing condition may include at least one of pressure of the piercing unit for generating the hole, a speed of the piercing unit for generating the hole, a depth of the hole, a position of the hole on the metal drawing material, and a diameter of the hole.

The predetermined cutting condition may include at least one of the speeds of the cutting unit, a movement direction of the cutting unit, and a cutting position of the material.

In summary, by the method of fabricating a terminal plate according to the exemplary embodiment of the present invention, the predetermined condition for fabricating the terminal plate may be input (S201). The predetermined condition input through step S201 may be, for example, at least one of a predetermined transport condition including the transport direction of the metal drawing material, a predetermined piercing condition including the pressure of the piercing unit for generating the hole, and a predetermined cutting condition including the speed of the cutting unit. The metal drawing materials generated through the first drawing process, the rolling process, and the second drawing process may be transported based on the predetermined transport condition (S210). When the metal drawing material is transported to the location of the piercing unit, the hole may be generated based on the predetermined piercing condition (S220). Additionally, when the metal drawing material with the hole is transported to the location of the cutting unit, the metal drawing material with the hole may be cut based on the predetermined cutting condition (S230).

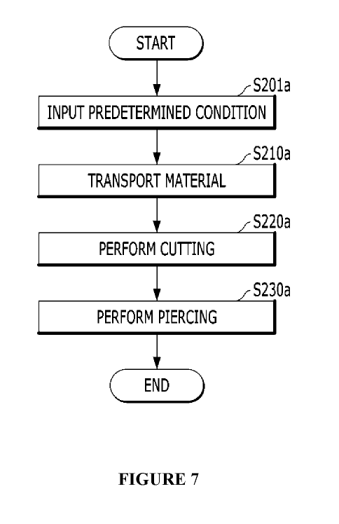

FIG. 7 is a flowchart of a method of fabricating a terminal plate according to another exemplary embodiment of the present invention.

Referring to FIG. 7, another exemplary embodiment for fabricating the terminal plate is disclosed.

By the method of fabricating a terminal plate according to another exemplary embodiment of the present invention, a predetermined condition may be input (S201a).

A material transporting step (S210a) of transporting a metal drawing material having a quadrangular cross-section may be performed based on a predetermined transport condition. Since step S210a of FIG. 7 corresponds to step S210 of FIG. 6, detailed description thereof will be omitted.

Thereafter, a cutting step of cutting the metal drawing material transported to the location of a cutting unit may be performed based on a predetermined cutting condition (S220a). Step 220a of FIG. 7 corresponds to step S230 of FIG. 6 and step S220a of FIG. 7 is described with reference to the description of step S230 of FIG. 6.

The piercing step of generating the hole in the cut metal drawing material transported to the location of a piercing unit based on the predetermined piercing condition (S230a). Step 230a of FIG. 7 corresponds to step S220 of FIG. 6 and step S230a of FIG. 7 is described with reference to the description of step S220 of FIG. 6.

The material supplying step, the cutting step, and the piercing step may be consecutively performed in one fabricating apparatus or fabricating process or individually performed in a plurality of fabricating apparatuses or a plurality of fabricating processes.

Next, a system of fabricating a terminal plate, which is used for implementing the method of fabricating the terminal plate described in FIGS. 6 and 7 will be described.

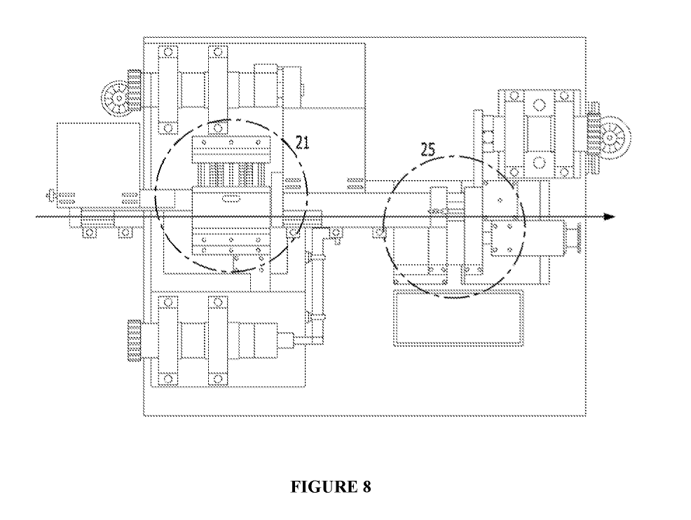

FIG. 8 is a plan view of a system of fabricating a terminal plate according to an exemplary embodiment of the present invention.

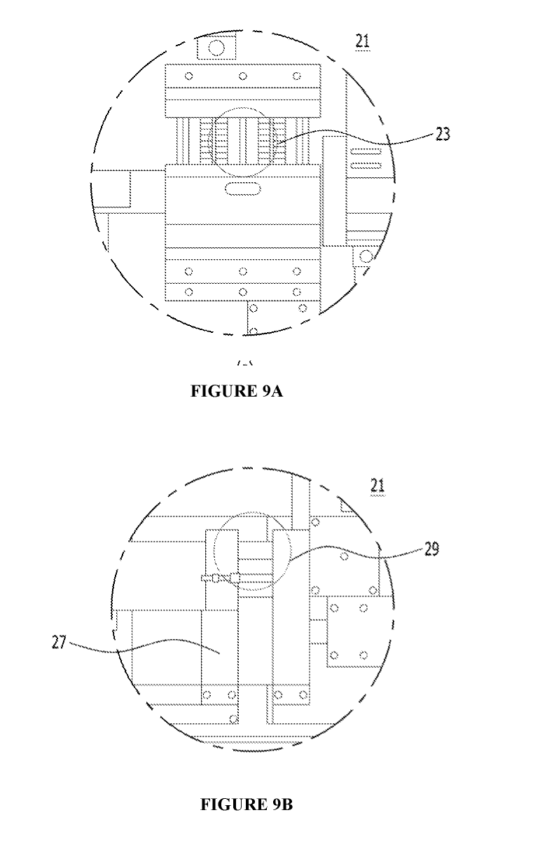

FIGS. 9A-9B are plan views of a piercing part and a cutting unit of a system of fabricating a terminal plate according to an exemplary embodiment of the present invention.

Referring to FIGS. 8 and 9A-9B, a system of fabricating a terminal plate according to an exemplary embodiment of the present invention may include a material transport unit, a piercing unit 21, and a cutting unit 25.

In FIGS. 8 and 9A-9B, the system of fabricating the terminal plate will be described based on the method of fabricating the terminal plate illustrated in FIG. 6.

A material transport unit according to the exemplary embodiment of the present invention may transport a metal drawing material having a quadrangular section based on a predetermined transporting condition. The material transport unit may include, for example, a rail installed for transporting a material (here, a metal drawing material) and a transport cylinder controlling a motion of a gripper holding the material (here, the metal drawing material) while moving along the rail. The transport cylinder may be at least one of, for example, upper and lower transport cylinders, front and rear transport cylinders, and left and right transport cylinders. The transport cylinders may be controlled by a controller (not illustrated). Additionally, the transport cylinder may move by at least one of a driving motor and air pressure. Further, the gripper may have a differential shape in response to a shape and a thickness of the material. Further, the material transport unit may be formed so that the gripper loads the material when the material (here, the metal drawing material) is seated at a predetermined transport position (for example, a position of the cutting unit). The material transport unit described above is exemplarily disclosed according to the exemplary embodiment of the present invention and the present invention is not limited thereto.

The system for fabricating the terminal plate may additionally include an input unit receiving at least one of a predetermined transport condition, a predetermined cutting condition, and a predetermined piercing condition.

The predetermined condition may include at least one of the predetermined transport condition, the predetermined piercing condition, and the predetermined cutting condition. The predetermined transport condition may include at least one of for example, a transport direction, a transport length, a transport speed, and a transport position of the metal drawing material. Further, the predetermined piercing condition may include at least one of pressure of the piercing unit for generating the hole, a speed of the piercing unit for generating the hole, a depth of the hole, a position of the hole on the metal drawing material, and a diameter of the hole.

The piercing unit 21 according to the exemplary embodiment of the present invention may generate a hole in the metal drawing material transported to the position of the piercing unit based on the predetermined piercing condition.

The piercing unit 21 according to the exemplary embodiment of the present invention may include a hydraulic piercing means 23 (for example, a piercing punch) (see FIG. 9A) to process a piercing hole in the metal drawing material 1c by generating hydraulic pressure by operation of an upper die.

For example, when the metal drawing material 1c transported to the piercing unit 21 is pressurized at high pressure by using a hydraulic cylinder (not illustrated), the piercing punch 23 processes the piercing hole in the metal drawing material 1c. In this case, a scrap separated from the metal drawing material is discharged down through an outlet formed below the piercing unit 21. As such, when left and right molds operate backwards after processing the piercing hole in the metal drawing material 1c, the piercing punch 23 (see FIG. 9A) returns to an original position. In this case, the predetermined piercing condition may include at least one of pressure of the piercing punch, a shape of a predetermined section of the piercing punch, and a moving speed of the piercing punch.

The aforementioned operation of the piercing unit 21 is just an example of the method of fabricating the terminal plate according to the present invention and the scope of the present invention is not limited thereto. For example, the piercing unit 21 may be any driving device capable of generating the hole in the metal drawing material 1c by a vertical reciprocating motion other than the piercing punch 23 (see FIG. 9A).

The cutting unit 25 according to the exemplary embodiment of the present invention may cut the metal drawing material in which the hole transported to the position of the cutting unit is generated, based on the predetermined cutting condition. Referring to FIG. 9B, the cutting unit 25 may include a material fixing unit 27 fixing the metal drawing material 1c and a material cutting unit 29 cutting the metal drawing material. The material cutting unit 29 may be formed with a material and a shape capable of cutting the metal drawing material 1c. For example, the material cutting unit 29 may be a pipe-shaped cutter of which a cross section of two sides is formed in a blade shape, but the scope of the present invention is not limited thereto. Further, the cutting unit 25 may further include the material fixing unit 27 to limit motion of the metal drawing material 1c in which the hole transported to the position of the cutting unit 25 is generated. As a result, precise cutting of the metal drawing material 1c may be performed.

The material cutting unit 29 may be at least one of for example, a cutting knife and a cutting saw having cutting blades. The material cutting unit 29 may be formed with a material and a shape capable of cutting the material (here, the metal drawing material) and preferably, formed with a material having higher strength than that of the material. Further, the material cutting unit 29 may be constituted to have an upper cutting unit positioned at the upper side of the material and a lower cutting unit positioned at the lower side of the material. In this case, the upper cutting unit moves to the lower side from the upper side of the material and the lower cutting unit moves to the upper side from the lower side of the material to cut the material. Here, the aforementioned material cutting unit 29 is just an example according to the exemplary embodiment of the present invention and the scope of the present invention is not limited thereto.

The system for fabricating the terminal plate according to the exemplary embodiment of the present invention may further include an air sprayer for removing a scrap generated by the piercing unit 21 and the cutting unit 25.

The material transport unit, the piercing unit 21, and the cutting unit 25 described above are disposed in a straight line at intervals to stepwise generate the hole in the transported metal drawing material 1c and cut the metal drawing material with a dimension optimized for a volume amount of a finished product. Alternatively, the material transport unit, the cutting unit 25, and the piercing unit 21 are disposed in a straight line at intervals to stepwise cut the transported metal drawing material 1c with a dimension optimized for a volume amount of a finished product and generate the hole.

According to the method of fabricating the terminal plate according to the exemplary embodiment of the present invention described above with reference to FIGS. 6 to 9B, grooves may be generated in the metal drawing material to be spaced apart from each other by a predetermined length unit. Further, the terminal plate optimized for the volume amount of the finished product may be generated in the metal drawing material by cutting the metal drawing material based on the predetermined dimension.

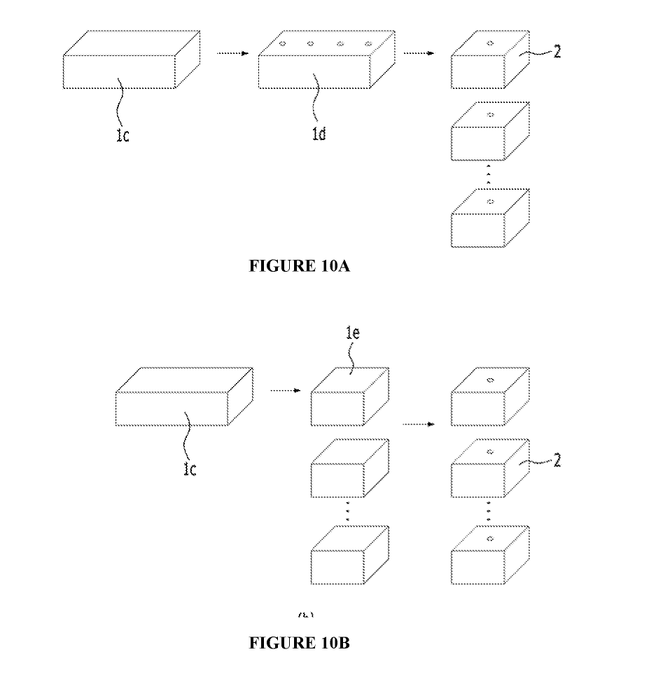

FIGS. 10A-10B illustrate a generated terminal plate and a material of the terminal plate generated in each process according to an exemplary embodiment of the present invention.

FIG. 10A illustrates the terminal plate generated according to the method described above in FIG. 6 and a material of the terminal plate generated in each process.

FIG. 10B illustrates the terminal plate generated according to the method described above in FIG. 7 and a material of the terminal plate generated in each process.

Referring to FIGS. 10A and 10B, the metal drawing material 1c may be generated by the first drawing process, the rolling process, and the second drawing process which are described above with reference to FIGS. 1 to 5B.

Referring to FIG. 10A, the hole may be generated by the piercing unit in the metal drawing material 1c transported to the position of the piercing unit (1d). Thereafter, based on the cutting condition predetermined according to the cutting step, the metal drawing material in which the hole transported to the position of the cutting unit is generated may be cut.

That is, the metal drawing material 1c generated by the first drawing process, the rolling process, and the second drawing process may be cut at predetermined unit intervals to be generated to a plurality of terminal plates 2, after the holes are generated at the predetermined unit intervals by the piercing process (1d).

Alternatively, referring to FIG. 10B, the metal drawing material 1c transported to the position of the cutting unit may be cut to a plurality of metal drawing materials 1e based on the predetermined cutting condition. The plurality of metal drawing materials 1e is transported to the position of the piercing unit to be generated to the plurality of terminal plates 2 by generating the hole in each metal drawing material 1e based on the predetermined piercing condition.

The terminal plate 2 generated according to the exemplary embodiment of the present invention has more uniform hardness than an existing terminal plate and hardness, surface precision, and dimensional precision of the terminal plate may be improved. Accordingly, durability of the terminal plate may be further improved.

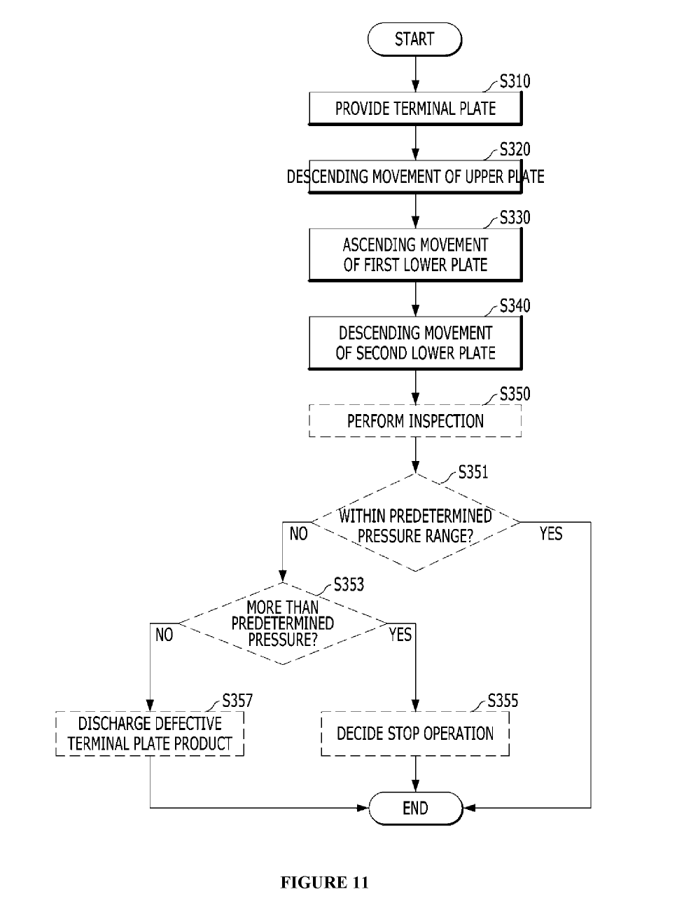

Hereinafter, a method and an apparatus of fabricating a terminal plate product for the terminal plate 2 will be described with reference to FIGS. 11 to 14.

First, a method of fabricating a terminal plate product according to an exemplary embodiment of the present invention will be described with reference to FIG. 11.

FIG. 11 is a flowchart of a method of fabricating a terminal plate product according to an exemplary embodiment of the present invention.

In the present invention, in order to fabricate the terminal plate product, the terminal plate generated by piercing and cutting the metal drawing material which is fabricated by the first drawing process, the rolling process, and the second drawing process described above with reference to FIGS. 1 to 10B is adopted as a processed material. The metal terminal plate includes preferably a metal wire with conductivity and may include, for example, an aluminum material, a magnesium material, a titanium material, a steel material, a copper material, and the like. In order to fabricate the terminal plate product by using the terminal plate, the present invention performs processes to be described below. Additionally, the terminal plate product fabricated according to the exemplary embodiment of the present invention may be used, for example, for a secondary battery and the scope of the present invention is not limited thereto.

According to the exemplary embodiment of the present invention, in order to fabricate the terminal plate product, the terminal plate may be provided to a die plate with one or more spaces in which the terminal plates are accommodated.

According to the exemplary embodiment of the present invention, the die plate may have any shape with any material in which one or more spaces may be formed. The one or more spaces may be, for example, cavities or through-holes. The cavity or the through-hole may accommodate the terminal plate. Further, at least a part of an upper plate, a first lower plate, and a second lower plate may be inserted into the through-hole according to ascending and descending movement of at least one of the upper plate, the first lower plate, and the second lower plate. For example, the die plate may be formed in a vertically bent shape and made of a material tolerable to pressure which is simultaneously applied by the upper plate and the first lower plate or the upper plate and the second lower plate.

According to an additional exemplary embodiment of the present invention, the one or more spaces may be closely coupled with at least one of the first lower plate and the second lower plate according to the ascending movement of the first lower plate and the second lower plate.

According to an exemplary embodiment of the present invention, the upper plate which is positioned at the top of the die plate and may ascend and descend may descend in order to pressurize at least a part of the top of the terminal plate accommodated in one or more spaces (S320).

At least one of the first lower plate and the second lower plate may pressurize at least a part of the bottom of the terminal plate accommodated in the die plate through the ascending movement. The ascending movement of at least one of the first lower plate and the second lower plate may be performed simultaneously with the descending movement of the die plate.

The second lower plate which is positioned below the first lower plate and may ascend and descend while one or more molding pins which pressurizes at least a part of the bottom of the terminal plate are coupled with the top ascends to generate grooves corresponding to one or more molding pins in at least a part of the bottom of the terminal plate. This will refer to FIG. 13. Additionally, the ascending movement of the second lower plate may be simultaneously performed with the descending movement of the die plate.

In other words, the terminal plate accommodated in the die plate may be pressed by receiving any pressure from the top and the bottom of the terminal plate. That is, the terminal plate accommodated in the die plate may be processed by receiving the pressure simultaneously or sequentially from at least one of the upper plate, the first lower plate, and the second lower plate.

According to the exemplary embodiment of the present invention, the first lower plate which is positioned below the die plate and may ascend and descend may ascend in order to discharge the pressurized terminal plate (S330).

With respect to the terminal plate provided by step S310, when the pressurizing process is completed through step S320, step S330 starts. The first lower plate ascends to the die plate in which the pressurized terminal plate, that is, the terminal plate product is accommodated and thus the terminal plate product may be discharged.

After step S330 is performed, according to the exemplary embodiment of the present invention, the second lower plate which is positioned below the first lower plate and movable up and down while one or molding pins which pressurizes at least a part of the bottom of the terminal plate are coupled with the top may descend so as to separate the molding pin from the processed terminal plate (S340). Additionally, the descending movement of the second lower plate may be performed after the ascending movement of the first lower plate.

According to an additional exemplary embodiment of the present invention, steps S330 and S340 may be almost simultaneously performed.

In order to fabricate the terminal plate product through the aforementioned steps, preferably, constant pressure needs to be transferred to the terminal plate. To this end, one or more press punches 31 (see FIG. 13) protruding downward in a region below the upper plate 30 may descend to a predetermined position.

According to the exemplary embodiment of the present invention, the terminal plate provided through the step S310 needs to be provided in a predetermined shape. The predetermined shape may mean a limitation condition for at least one of for example, a shape of the terminal plate, hardness of the terminal plate, and a predetermined position of the terminal plate. Additionally, the limitation condition may be a range including a tolerance. The aforementioned predetermined shape may be input from a user in advance to be stored in a memory (not illustrated).

When the terminal plate provided through step S310 is provided in a non-predetermined shape, the pressure applied to the terminal plate may deviate from the predetermined pressure range.

In more detail, when the pressure applied to the terminal plate is measured to be higher than predetermined pressure (preferably, the range including the tolerance), the terminal plate product fabricated through steps S310 to S340 may be fabricated to have a thickness larger than a predetermined thickness. As another example, when the pressure applied to the terminal plate is measured to be lower than the predetermined pressure, the thickness of the terminal plate product fabricated through steps S310 to S340 may be fabricated smaller than the predetermined thickness.

The method of fabricating the terminal plate product according to the additional exemplary embodiment of the present invention may further include an inspecting step (S350). In the inspecting step (S350), the pressure applied to the terminal plate may be measured through steps S310 to S340.

The inspecting step (S350) according to the exemplary embodiment of the present invention may adopt, for example, a pressure load cell method. When the load cell is weighted, deformation such as decompression or stretching occurs, and a deformation measuring apparatus may detect a deformation amount as an electrical signal. The load cell may be a tension type, a compression type, and a combination type and the present invention is not limited thereto.

The inspecting step (S350) may be performed by a predetermined period unit. The inspecting step (S350) may, for example, be performed at an interval of 3 minutes after steps S310 to S340 are performed. As yet another example, whenever the terminal plate is provided through step S310, the inspecting step may be performed. When the inspecting is performed each time, occurrence of defects of all the fabricated terminal plate products may be verified. Here, the occurrence of defects of the terminal plate products may mean a case where the pressure applied to each terminal plate measured through the inspecting step (S350) is not present within the predetermined pressure range.

According to the exemplary embodiment of the present invention, the defective terminal plate products specified through the inspecting step (S350) may be discharged to a defect outlet. That is, even when the pressure applied to the terminal plate through the inspecting step (S350) deviates from the predetermined pressure range, the processes do not stop and a continuous process may be performed. As a result, it is possible to increase completion of the terminal plate product and improve productivity.

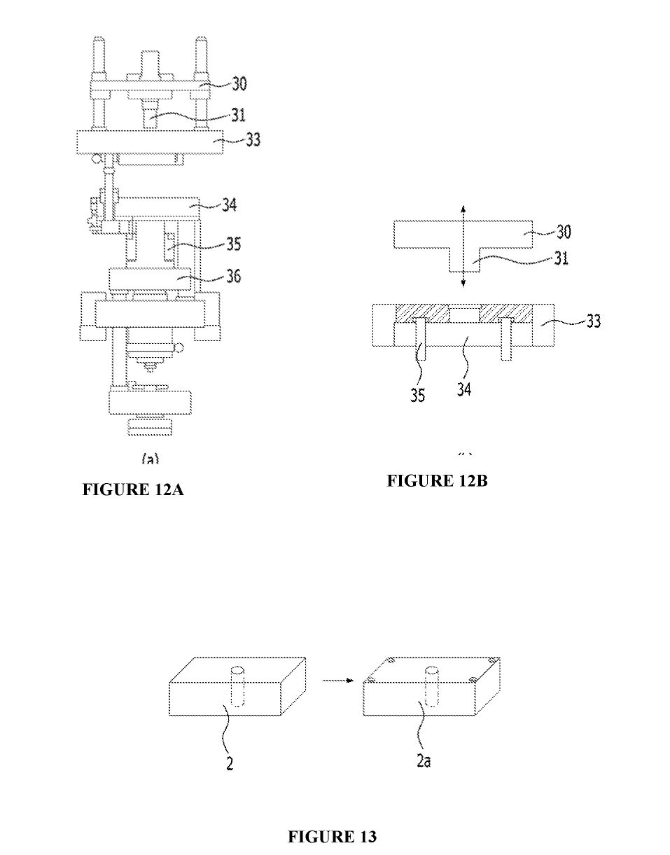

When the pressure measured in the inspecting step (S350) is measured as the predetermined pressure or more, it may be determined that steps S310 to S340 are not performed. As a result, maintenance for the apparatus for fabricating the terminal plate product (see FIG. 12) may be performed. Here, the predetermined pressure may be partially determined based on the material of the terminal plate. Further, the predetermined pressure may be determined as any value. For example, the predetermined pressure may be determined to two times larger than a difference between the predetermined pressure range and the measured pressure.

In more detail, the method of fabricating the terminal plate product according to the exemplary embodiment of the present invention may additionally include verifying (S351) whether the pressure (that is, the pressure applied to the terminal plate) measured through step S350 is included in the predetermined pressure range.

When the pressure measured through step S350 is not included in the predetermined pressure range, whether the measured pressure exceeds the predetermined pressure may be determined (S353).

When the pressure measured through step S350 exceeds the predetermined pressure, the operation stop may be determined so as not to perform steps S310 to S340 for fabricating the terminal plate product (S355).

When the pressure measured through step S350 is not included in the predetermined pressure range, and does not exceed the predetermined pressure, the terminal plate product fabricated through steps S310 to S340 may be determined as a defective product and determined to discharge the defective terminal plate product (S357).

Steps S351 to S357 may be performed by, for example, a computer readable storage medium including one or more processors and a memory. The storage medium may include all kinds of storage media storing programs and data to be readable by the computer system.

The aforementioned memory may include at least one storage medium of a flash memory type storage medium, a hard disk type storage medium, a multimedia card micro type storage medium, a card type memory (for example, an SD or XD memory, or the like), a random access memory (RAM), a static random access memory (SRMA), a read-only memory (ROM), an electrically erasable programmable read-only memory (EEPROM), a programmable read-only memory (PROM), a magnetic memory, a magnetic disk, and an optical disk.

Next, for implementing the method of fabricating the terminal plate product described above in FIG. 11, an apparatus of fabricating the terminal plate product will be described.

FIGS. 12A-12B illustrate a plan view of an apparatus of fabricating the terminal plate product according to an exemplary embodiment of the present invention.

FIG. 12A is a plan view of an apparatus of fabricating the terminal plate product according to an exemplary embodiment of the present invention. FIG. 12B illustrates a die plate, a first lower plate, and a second lower plate operating for fabricating the terminal plate product according to the exemplary embodiment of the present invention.

FIG. 13 illustrates the terminal plate product generated according to an exemplary embodiment of the present invention. The apparatus of fabricating the terminal plate product according to an exemplary embodiment of the present invention of FIGS. 12A-12B will be described with reference to FIG. 13.

A terminal plate product 2a illustrated in FIG. 13 is a diagram illustrating a lower surface of the terminal plate product fabricated according to the exemplary embodiment of the present invention upwards. This is to illustrate one or more grooves formed on the lower surface of the terminal plate product 2a fabricated according to the exemplary embodiment of the present invention. Further, the scope of the present invention is not limited to the illustrated drawing.

The apparatus of fabricating the terminal plate product according to the exemplary embodiment of the present invention includes an upper plate 30, a die plate 33, a first lower plate 34, and a second lower plate 36. The aforementioned constituent elements are just exemplarily disclosed in the apparatus of fabricating the terminal plate product according to the exemplary embodiment of the present invention and other constituent elements which are not disclosed may be included in the apparatus.

The die plate 33 according to the exemplary embodiment of the present invention may be formed with one or more spaces. The one or more spaces may be cavities or through-holes. Further, the one or more spaces may be formed in a combination of the cavities or the through-holes.

According to the exemplary embodiment of the present invention, a terminal plate 2 for processing may be accommodated in the one or more spaces formed in the die plate 33.

When the one or more spaces formed in the die plate 33 are the through-holes, at least a part of the first lower plate 34 or the second lower plate 36 may be inserted into the through-hole. That is, the first lower plate 34 and/or the second lower plate 36 may include a punch protruding upward in one region (for example, an upper surface). For example, the die plate 33 may be closely coupled with at least one of the first lower plate 34 and the second lower plate 36 according to the ascending movement of the first lower plate 34 and the second lower plate 36. As a result, the terminal plate product 2a may be discharged to the outside of the die plate 33.

As described above, the die plate 33 is fixed and thus the movement may be limited.

The upper plate 30 according to the exemplary embodiment of the present invention is positioned at the top of the die plate 33. The die plate 33 may ascend and descend. For example, the upper plate 30 descends to pressurize at least a part of the top of the terminal plate 2 accommodated in the one or more spaces.

According to another exemplary embodiment of the present invention, the terminal plate 2 accommodated in the die plate 33 may be pressurized and processed simultaneously from the first lower plate 34 and the upper plate 30.

According to yet another exemplary embodiment of the present invention, the terminal plate 2 accommodated in the die plate 33 may be processed from the pressurization of the second lower plate 36 and the upper plate 30.

The upper plate 30 may further include one or more press punches 31 protruding downward in one region of the bottom of the upper plate 30. The press punch 31 may be formed to have any cross section and preferably, may be a circular or multi-step punch having a predetermined diameter. The upper plate 30 and the press punch 31 may additionally include fastening parts so that the press punch 31 may be separated from and coupled with the upper plate 30. As a result, another press punch 31 may be easily installed based on at least one of a material of the terminal plate product, a diameter of the hole, and a shape of the hole.

The press punch 31 may be inserted to any position of the hole generated in the terminal plate 2 according to the descending movement of the upper plate 30. Through the process, the terminal plate product 2a with higher and uniform hardness and improved surface precision and size precision may be generated. Further, scraps in the hole of the terminal plate 2 generated according to the method of fabricating the terminal plate described above through FIGS. 6 to 9 may be arranged without a separate processing.

According to an exemplary embodiment of the present invention, a position at which the press punch 31 is formed at the upper plate 30 and a predetermined diameter of the press punch 31 may be determined to correspond to the terminal plate 2. Additionally, a single jaw may be formed to be positioned in any region of the press punch 31.

That is, the press processing of the single jaw part and the grooves requiring high precision which are formed in the hole of the terminal plate product 2a may be precisely and efficiently performed by processing the single jaw part and the grooves by the press punch 31 including the single jaw in the any region and the molding pin 35.

The first lower plate 34 according to the exemplary embodiment of the present invention is positioned below the die plate 33. The first lower plate 34 may ascend and descend. Further, the first lower plate 34 ascends to discharge the pressurized terminal plate, that is, the terminal plate product 2a.

In more detail, in order to easily discharge the terminal plate product 2a in which the press processing is completed, the first lower plate 34 ascends to lift the pressurized terminal plate positioned on the upper surface of the die plate 33, that is, the terminal plate product 2a on the upper surface of the die plate 33 to easily discharge the terminal plate product 2a.

The second lower plate 36 according to the exemplary embodiment of the present invention is positioned below the first lower plate 34. The second lower plate 36 may ascend and descend. Further, the second lower plate 36 may include one or more molding pins 35 above the second lower plate 36. That is, in the second lower plate 36, one or more grooves may be generated in at least a part of the bottom of the terminal plate 2 to correspond to the one or more molding pins through the ascending movement of the second lower plate 36.

According to an additional exemplary embodiment of the present invention, the metal pin 35 may be coupled with the first lower plate 34.

According to an additional exemplary embodiment of the present invention, the second lower plate 36 descends to separate the molding pin 35 from the processed terminal plate 2a (that is, the terminal plate product).

Although not illustrated, according to an additional exemplary embodiment of the present invention, the first lower plate 34 or the second lower plate 36 may further include a punch protruding upward in one region of the first lower plate 34 or the second lower plate 36.

The apparatus described with reference to FIGS. 12A-12B may be one of a powder molding press and a sizing press.

The terminal plate product generated according to the apparatus of fabricating the terminal plate product according to the exemplary embodiment of the present invention described above in FIGS. 12A-12B is represented by reference numeral 2a of FIG. 13. In more detail, in the terminal plate product, the hole in which the single jaw part is formed in any region is formed at the center and one or more grooves are generated on the upper surface or the lower surface thereof. For example, referring to FIG. 13, the terminal plate product 2a has a shape in which the hole in which the single jaw part is formed at the upper end is positioned at the center of the terminal plate product 2a and the grooves are formed at four positions which are symmetrical to each other on each diagonal line of the lower surface of the terminal plate product 2a.

In order to fabricate the terminal plate product, a circular drawn article is generally fabricated through cold forging and cutting processing in the related art. In the case of fabricating the terminal plate product through cold forging and cutting processing, there are problem in that a lot of time for processing is required and fabricating cost is very high.

In the terminal plate product 2a according to the method of fabricating the terminal plate product according to the exemplary embodiment of the present invention, a parting surface due to the cutting of the terminal plate 2 may be minimized.

According to the method of fabricating the terminal plate product according to the exemplary embodiment of the present invention, variety of selection of the processed material or precision thereof may be improved and less time for processing is required, and thus the fabricating cost may be reduced.

That is, according to the exemplary embodiment of the present invention, the terminal plate product may be rapidly and efficiently mass-produced and thus the fabricating cost of the terminal plate product may be reduced while maintaining high precision.

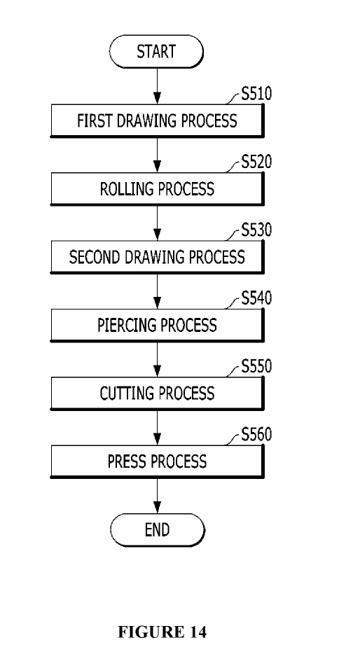

FIG. 14 is a flowchart of a method of fabricating a terminal plate product with a metallic wire according to an exemplary embodiment of the present invention.

A method for fabricating a terminal plate product with a metallic wire according to an exemplary embodiment of the present invention will be briefly described with reference to FIG. 14.

First, steps S510 to S530 are to fabricate a material of the terminal plate.

Steps S510 to S530 may correspond to steps S110 to S130 described above in FIG. 1. That is, in order to fabricate the terminal plate product, the terminal plate material may be fabricated from a metallic wire. In more detail, the metallic wire may be generated as a quadrangular or multi-step-shaped metal drawing material through a first drawing process (S510), a rolling process (S520), and a second drawing process (S530). The metal drawing material generated by the processes has more uniform hardness than the metallic wire and improved hardness, surface degree, and dimensional precision.

Next, steps S510 to S530 are to fabricate the terminal plate in which a uniform length unit is cut by the unit of a uniform length and the hole is generated based on the predetermined piercing condition and the predetermined cutting condition from the material for fabricating the terminal plate.

The metal drawing material generated through steps S510 to S530 may be generated to the terminal plate through steps S540 and S550. That is, when the metal drawing material is transported to the position of the piercing unit, the hole may be generated in the metal drawing material based on the predetermined piercing condition. Further, when the drawing material with the generated hole is transported to the position of the cutting unit, the metal drawing material may be cut based on the predetermined cutting condition. Since steps S540 and S550 correspond to steps S220 and S230 described in FIG. 6, a detailed description will be omitted. Further, steps S540 and S550 may be performed by varying the order. The terminal plate generated by the processes has more uniform hardness than the terminal plate in the related art and improved hardness, surface degree, and dimensional precision.

The first drawing process, the rolling process, the second drawing process, the piercing process, and the cutting process may be consecutively performed in one fabricating apparatus or fabricating process or individually performed in a plurality of fabricating apparatuses or a plurality of fabricating processes.

Next, step S550 is to fabricate the terminal plate product in which the groove is generated from the terminal plate and a hole and a groove including the single jaw are generated.

The terminal plate generated through steps S540 to S550 may have one or more grooves on the bottom thereof through the press process (S550). Additionally, the circular or single-jaw punch is inserted into a predetermined location of the hole of the terminal plate to process the single jaw in the hole or improve the size precision of the hole. The press process (S550) may include steps S310 to S340 of FIG. 11. As described above in FIG. 11, in the press process (S550), the terminal plate positioned on the die plate is pressed and process through the ascending and descending movement of the upper plate, the first lower plate, and the second lower plate. The terminal plate product generated through the press process (S550) has more uniform hardness and improved hardness, surface precision, and size precision than the terminal plate generated through steps S540 to S550.

In more detail, in a method of fabricating a terminal plate product in the related art, in respect to metal, for example, a presser presses a molding frame on an aluminum material. In this case, the terminal plate product is pressed in the shape of the molding frame and the pressing is repeated several times in order to generate the hole having the step in a predetermined area (for example, the center) of the aluminum material to fabricate the terminal plate molded article.

However, when the terminal plate product is fabricated through the cold forging, it is difficult to implement various shapes and exterior quality of the terminal plate molded article deteriorates. Further, a cycle time in the cutting process is longer than the cycle time and a processing facility is more expensive than the processing facility in a press operation.

That is, a complicated process is required to fabricate the terminal plate product and a generation speed of the terminal plate product is low. Moreover, the hardness between predetermined areas of the terminal plate product is not uniform, and as a result, durability is low.

According to the method of fabricating the terminal plate product according to the exemplary embodiment of the present invention, the hardness of the terminal plate product may be uniformalized. Hardness, surface hardness, surface precision, and size precision of the terminal plate product may be improved. Additionally, according to the exemplary embodiment of the present invention, cost required to fabricate the terminal plate product may be reduced.

Various embodiments described herein may be implemented in a computer-readable recording medium or a recording medium readable by a device similar to the computer by using, for example, software, hardware, or a combination thereof.

According to an aspect of the present invention, the media may include a read only memory (ROM), a random access memory (RAM), a compact disk (CD)-ROM, a digital video disk (DVD)-ROM, a magnetic tape, a floppy disk, an optical data storage device, and the like and also include media implemented in the form of a carrier wave (for example, transmission through the Internet). Additionally, the media are distributed to systems connected through network modules to store computer readable codes and/or commands in a distribution scheme.

According to hardware implementation, the exemplary embodiment described herein may be implemented by using at least one of ASICs (application specific integrated circuits), DSPs (digital signal processors), DSPDs (digital signal processing devices), PLDs (programmable logic devices), FPGAs (field programmable gate arrays), processors, controllers, micro-controllers, microprocessors, and electric units for performing other functions. In some cases, the embodiments described in the specification may be implemented by the controller (not illustrated itself.

According to software implementation, embodiments such as a procedure and a function described in the specification may be implemented by separate software modules. Each of the software modules may perform one or more functions and operations described in the specification. A software code may be implemented by a software application written by an appropriate program language. The software code may be stored in a memory (not illustrated) and executed by a controller (not illustrated).

The description of the presented exemplary embodiments is provided so that those skilled in the art of the present invention use or implement the present invention. It will be apparent to those skilled in the art that various modifications of the exemplary embodiments will be apparent to those skilled in the art and general principles defined herein can be applied to other exemplary embodiments without departing from the scope of the present invention. Therefore, the present invention is not limited to the exemplary embodiments presented herein, but should be analyzed within the widest range which is associated with the principles and new features presented herein.

What is claimed is:

1. An apparatus of fabricating a terminal plate product, the apparatus comprising:
a die plate having one or more spaces in which a terminal plate is received;
an upper plate which is positioned on the top of the die plate, is movable to ascend and descend, and presses and processes at least a part of the top of the terminal plate received in one or more spaces through descending movement;
a first lower plate which is positioned on the bottom of the die plate, is movable to ascend and descend, and discharges the pressed and processed terminal plate while ascending; and
a second lower plate which is positioned on the bottom of the first lower plate, is movable to ascend and descend, and has one or more molding pins, and which press and process at least a part of the bottom of the terminal plate through ascending movement, coupled to the top, and separates the molding pin from the processed terminal plate during descending movement.

2. The apparatus of claim 1, wherein the ascending movement of the second lower plate is simultaneously performed with the descending movement of the die plate.

3. The apparatus of claim 1, wherein the descending movement of the second lower plate is performed after the ascending movement of the first lower plate.

4. The apparatus of claim 1, wherein at least one of the first lower plate and the second lower plate presses and processes at least a part of the bottom of the terminal plate received in the die plate through the ascending movement.

5. The apparatus of claim 1, wherein in the pressing and processing through the ascending movement of the second lower plate, one or more grooves are generated on at least a part of the bottom of the terminal plate corresponding to one or more molding pins.

6. The apparatus of claim 1, wherein the upper plate further includes a punch which has a predetermined diameter at one area of the bottom of the upper plate and protrudes downward, and
the punch is inserted into a predetermined location of a hole generated in the terminal plate with the descending movement of the upper plate.

7. The apparatus of claim 6, wherein the punch is one of a circular punch and a step punch.

8. The apparatus of claim 1, wherein one or more spaces are closely coupled with at least one of the first lower plate and the second lower plate according to the ascending movement of the first lower plate and the second lower plate.

9. The apparatus of claim 1, wherein the apparatus is one of a powder molding press and a sizing press.

10. The apparatus of claim 1, wherein the terminal plate is generated by performing a piercing process and a cutting process of a metal drawing material fabricated through a prior drawing process, a rolling process, and a post drawing process.

11. The apparatus of claim 1, wherein the first lower plate or the second lower plate further include a punch which protrudes upward at one area of the first lower plate or the second lower plate.

12. A method of fabricating a terminal plate product, the method comprising:
providing a terminal plate to a die plate with one or more spaces in which the terminal plate is received;
making an upper plate, which is positioned on the top of the die plate and is movable to ascend and descend, descend in order to press and process at least a part of the top of the terminal plate received in one or more spaces through descending movement;
making a first lower plate, which is positioned on the bottom of the die plate and is movable to ascend and descend, ascend in order to discharge the pressed and processed terminal plate; and
making a second lower plate which is positioned on the bottom of the first lower plate and movable to ascend and descend while one or molding pins which press and process at least a part of the bottom of the terminal plate are coupled to the top descend so as to separate the molding pin from the processed terminal plate.

13. A terminal plate product generated by a following method of fabricating the terminal plate product, wherein the method includes:
providing a terminal plate to a die plate with one or more spaces in which the terminal plate is received;
making an upper plate, which is positioned on the top of the die plate, is movable to ascend and descend, descend in order to press and process at least a part of the top of the terminal plate received in one or more spaces through descending movement;
making a first lower plate, which is positioned on the bottom of the die plate and is movable to ascend and descend, ascend in order to discharge the pressed and processed terminal plate; and
making a second lower plate, which is positioned on the bottom of the first lower plate and movable to ascend and descend while one or molding pins which presses at least a part of the bottom of the terminal plate are coupled to the top, descend so as to separate the molding pin from the processed terminal plate.
